(19) United States
(12) Patent Application Publication
(10) Pub. No.: US 2025/0063368 A1
(43) Pub. Date: Feb. 20, 2025

(54) APPARATUS FOR SECURING COMMUNICATION

(71) Applicant: MERCEDES-BENZ GROUP AG, Stuttgart (DE)

(72) Inventors: Osman AYDIN, Leinfelden-Echterdingen (DE); Mei HUANG, Heidelberg (DE)

(21) Appl. No.: 18/722,316

(22) PCT Filed: Nov. 30, 2022
(86) PCT No.: PCT/EP2022/083937

§ 371 Date: Jun. 20, 2024

(30) Foreign Application Priority Data
Dec. 21, 2021 (DE) 10 2021 006 297.3

(51) Int. Cl. H04W 12/63; G01S 5/02; H04W 12/08

(52) U.S. Cl. CPC H04W 12/63; G01S 5/0284; H04W 12/08

(57) ABSTRACT

An apparatus for securing the communication between at least two subscribers via a communication device is provided. The two subscribers each have an identification and a security element to use for communication. The communication device is configured to authenticate at least one of the subscribers by determining the current geodetic position thereof by communicating with at least one transceiver to compare the currently detected position with a position transmitted or stored by the other subscriber or to check plausibility of the currently detected position based on the transmitted or stored position. The communication device is configured to detect the current position of the at least one subscriber by detecting and evaluating an angle of arrival of the signals used for communication and/or a signal strength of the signals used for communication.

### BACKGROUND AND SUMMARY OF THE INVENTION

Exemplary embodiments of the invention relate to an apparatus for securing communication between at least two subscribers to a method for securing communication between at least two subscribers, and a use of the apparatus and of the method.

Methods for communication between two or also more subscribers, which are secured accordingly, are known from the prior art. Typically, each of the subscribers has an identification, for example a user name, a user identifier or the like, and a security element for the communication, for example via a password-protected account or the like. The communication is then actually secured technically by means of encryption. The password is also the “key” for this.

The fundamental problem with such approaches is that there is always a risk of the subscriber's data being stolen, for example their ID and password. Criminal hackers can then take the place of the previous subscriber to contact the other subscriber and can use the ID and password known to them to make the other subscriber believe that they are the actually expected subscriber. This type of verification, which is so common and can also employ other measures such as storage media or the like instead of a password, is typically used for many types of communication. As the example set out above shows, however, it is not secure in the event that the user data is known to other people, or has been stolen or hacked.

As prior art, reference can be made to ALLIG, C. et al. Trustworthiness Estimation of Entities with Collective Perception; in: IEE Vehicular Networking Conference (VNC), 2019, 8 pages, ISSN 2157-9865 and also to standard ETSI EN 302 637-2 V1.3.2 (2014-11). Intelligent Transport Systems (IST); Vehicular Communications; Basic Set of Applications; Part 2: Specification of Cooperative Awareness Basic Service; pages 1 to 44. When viewed together, these fundamentally suggest verifying the position of a subscriber from two data sources.

Authenticating subscribers via their position is also described in DE 10 2020 003 329 A1 of the applicant. There, localization via satellites is used, for which the transit time of signals used for communication between the satellites and the subscriber(s) are analyzed. In a development of this, DE 10 2021 003 610 A1 describes a solution enabling position detection via the signal transit time even with fewer visible satellites.

The method described in the two cited publications of the applicant uses satellite localization and here, in particular, the analysis of the signal transit time of signals travelling to and from a plurality of satellites to detect the position of the respective subscriber on the earth's surface, i.e., to identify their actual physical or geodetic position. To authenticate the subscriber, their purported position can then be compared with their actual physical or geodetic position. If there are impermissibly high discrepancies when the positions are compared, then the authentication fails.

In practice, a hacker could now, for example, in principle position themselves very close to one of the subscribers, for example a geostationary server, to manipulate the information and adopt the role of this subscriber with the falsified frequency and identifier of the satellite and correspondingly higher signal strength. Despite the measures, data could thus be manipulated, for example a security-critical manipulation of software updates intended to be distributed to a vehicle fleet.

Exemplary embodiments of the present invention are directed to an apparatus for securing communication between subscribers that offers even greater security.

Aspects of the invention involve an apparatus for securing communication between at least two subscribers, a method for securing communication using such an apparatus, and a preferred use of the apparatus or of the method.

Disclosed are two alternative methods for identifying the current position of a subscriber for the purpose of authenticating this subscriber within the communication between the two subscribers via the respective apparatus configured for that end. To authenticate the subscriber, their purported position or their known or stored location can be compared with their actual physical or geodetic position.

According an aspect of the invention, the angle of arrival of the signals used for communication is detected and analyzed to identify the position. The geodetic position can be determined using trigonometric functions in a manner known per se from the angles of arrival of the signals from at least one transceiver, preferably from three different transceivers, in particular satellites.

According to one advantageous refinement, the angle of arrival, which is also known by the abbreviation AoA, can be detected via an antenna array of the communication device. If, for example, the drone of a hacker is located between one of the subscribers and a transceiver and pretends to be the transceiver, the angle of arrival of the signals will be different for the other subscriber than the expected angle of arrival for a real transceiver, e.g., because the drone is naturally much lower than the real transceiver, which can be a satellite in particular.

An alternative aspect substantially makes use of the same basic design and now uses a signal strength (SS) of the signals used for communication instead of the angle of arrival. The signal strength is based on the strength of the sent signal and the losses occurring over the transmission path, which are typically influenced by the corresponding atmospheric layers, the temperature and humidity thereof and the like. This signal strength can thus also be used to detect the position of the corresponding subscriber by deducing the distance to the transceiver from the incoming signal strength. In the case of preferably at least three transceivers, in particular satellites, the exact and unique geodetic position can be identified in this way.

Since the signal strength is subject to relatively strong fluctuations based on the ambient conditions, it can make sense here to include the ambient conditions as a parameter in the analysis, for example by taking weather data into account in order to be able to estimate the expected losses in the signal strength.

Nevertheless, a hacker could relatively easily simulate the signal strength of a subscriber by suitably amplifying or attenuating their own signal and thus authenticate themselves without authorization, in particular if they roughly know the order of magnitude of such a signal strength. This could be rectified by a further advantageous embodiment of the apparatus according to the invention, in which the communication device is configured to vary the signal strength of the outgoing signals dynamically over time according to a predefined pattern and to filter the incoming signals with respect to this predefined pattern. One subscriber could, as an example, provide the signals with a time variation so that, for example, the signals are attenuated by 5 dB at the start of the communication for a predefined period of time, increased by 10 dB in the middle of the communication and attenuated again at the end of the communication. A modulation of frequency, amplitude and/or polarization would also be conceivable. If the other part of the communication device, which receives the signals, recognizes this predefined pattern, it can filter it out again in order to be able to analyze the signal strength as such, and in the process further reduce the risk of intentional manipulation.

In addition to one or both of the methods described, the apparatus according to the invention can also be configured with respect to its communication device to use the detection of the current position of the at least one subscriber via the transit time of the signals used for communication between the transceivers, in particular satellites, and at least one of the subscribers. This determination of the position via the transit time, the so-called transfer time, which is abbreviated to TT, also offers a further—third—possibility for detecting the current position, which can basically be used as an alternative to the two physical methods presented here, as described in the prior art cited in the introduction, or also in addition thereto.

The communication device of the apparatus, which is configured to carry out the individual steps, can be arranged to some extent in each of the subscribers, so that they can detect each other's current position and use it to authenticate themselves.

According to a very advantageous refinement, a part of the communication device can, in particular, also be configured in the transceivers used, in particular satellites, if the computational capacities allow for this. In this case, authentication could already take place via the transceiver alone, so that any communication from a hacker identified as such via an incorrect position is not even forwarded, and could instead be blocked in the transceiver.

These principles can be applied to all possible types of transceiver satellites, in particular when stationary stations are involved as transceivers, e.g., transmission masts in the mobile phone network, radio or television stations or similar, which cover several moving objects as central transceivers. Particularly preferably, however, according to one advantageous embodiment of apparatuses according to the invention, the transceivers should be designed as satellites. In addition to the high availability of satellites, e.g., GPS and comparable systems) in almost all parts of the earth, these offer a high level of trust protection since it is virtually impossible for hacker groups to use a unique satellite to manipulate the authentication.

The method according to the invention for securing communication between at least two subscribers via such an apparatus now uses the comparison made in the communication device of the apparatus between a known position, for example the known geostationary position of a service center, which is already stored in the control system of a vehicle when it is manufactured, in order to ensure that the communication is actually taking place with the corresponding service center. Alternatively, in the case of moving objects such as vehicles as subscribers, it would also be possible to merely carry out a plausibility check. For example, the corresponding position of the vehicle could be temporarily stored from a previous communication in order to compare it with the current position. If the last communication took place several hours ago, for example, such a plausibility check can establish that the vehicle may be, for example, in a radius of 200 to 300 kilometers from the previous position. If this is the case, a positive plausibility check result is generated. If this is not the case and the distance is significantly greater than it can be under normal circumstances in this time, for example several thousand kilometers between the last stored position and the current position with a time interval of a few hours, then a negative plausibility check result would be generated. The method according to the invention for securing communication via such an apparatus will now abort the communication in the event of a negative comparison result or such a negative plausibility check result, since it can be assumed that the subscriber with the negative comparison result or the negative plausibility check result is to be classified as untrustworthy, in particular that it is a hacker who wants to send manipulated data to a user as the other subscriber or wants to intercept sensitive data belong to the corresponding subscriber.

A particularly favorable embodiment of the method according to the invention can provide that one, two or three of the cited methods are used to identify the position of the subscriber and authenticate the latter accordingly. It is thereby possible, depending on the situation, to perform the authentication via one or the other of the methods or even a mix of these methods, for example, which significantly increases security compared to using just one method.

In addition to pure authentication via one or more of the cited methods, it is also possible to use the described methods in such a way that one or two of the methods are used for authentication, i.e., to identify the actual position of the corresponding subscriber, while the further methods or the further method is used to validate this authentication accordingly, i.e., to again check the transmitted values directly or at least with regard to their plausibility. This can be carried out in any combination and/or order depending on the situation and, in particular, also depending on the available computational capacity of the respective subscriber. For example, it could be sufficient to analyze the angle of arrival and/or the signal strength of just one transceiver during an authentication via the signal transit time in order to validate the authentication. This saves resources and computational capacity.

The apparatus according to the invention or the method according to the invention in one or also the other variant can be used for securing any type of communication between subscribers, in order to validate various types of accounts with physical properties of the subscribers in the form of their position. The method is particularly suitable for securing communication between a service center of a vehicle manufacturer and the vehicles manufactured by the latter. According to a favorable use of the method according to the invention, it is provided that the method is used for securing communication between vehicles or servers and vehicles. This allows an appropriately secure communication to be established, as a result of which a very high level of security can be guaranteed with regard to the transmitted data. The method according to the invention makes it possible to provide a largely manipulation-free way of transmitting important information from a server of the vehicle manufacturer to the vehicle, for example, such as software updates with safety-critical content which comprise, for example, driving functions, driver assistance systems, autonomous driving functions and the like.

### BRIEF DESCRIPTION OF THE DRAWING FIGURES

Further advantageous embodiments of the apparatuses and method according to the invention also result from the exemplary embodiment which is set out in detail hereinbelow with reference to the figures, in which:

FIG. 1 shows an exemplary procedure for securing communication and for using the security element by means of the method according to the invention;

FIG. 2 shows a scenario for position identification by means of the signal transit time (TT) of satellites;

FIG. 3 shows a first scenario for position identification by means of the angle of arrival (AoA) of the signals;

FIG. 4 shows a second scenario for position identification by means of the angle of arrival (AoA) of the signals; and

FIG. 5 shows a scenario for position identification by means of the signal strength (SS).

### DETAILED DESCRIPTION

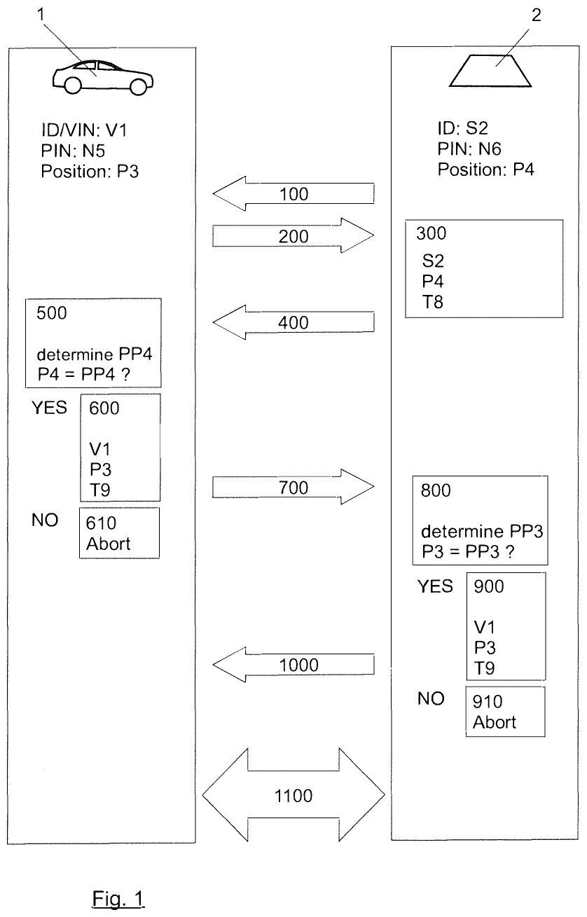

The illustration in FIG. 1 schematically sets out in several consecutive steps how the method according to the invention can function and be used. On the left-hand side of the illustration in FIG. 1, a subscriber 1 in the form of a vehicle 1 is shown; on the right-hand side of the illustration in FIG. 1, the subscriber 2 is, for example, a service center 2 of the vehicle manufacturer or the backend server thereof. The vehicle 1 communicates with the service center as subscriber 2 via a corresponding account. Its identification (ID) can, for example, be the vehicle identification number. In the exemplary embodiment shown here, it is V1. In addition, the vehicle 1 as a subscriber has a PIN, which is indicated here purely by way of example with N5. The service center 2 as a second subscriber also has an ID, which is indicated here with S2 by way of example. The PIN of the service center 2 is indicated with N6 by way of example. It is also the case that the two subscribers 1, 2 are in an appropriate position, i.e., they are at a geodetic position. In the event that the vehicle 1 is a subscriber, this position is indicated with P3 and, in the event that the service center 2 is a subscriber, it is indicated with P4.

In a first step 100, a request is sent from the service center 2 to the vehicle 1 with the identification V1, for example with the message that a software update is due. The vehicle 1, as subscriber with the identification V1, now establishes communication with the service center via its account with the identification V1 and the corresponding PIN and asks who has sent the message from the first step 100. This is the second step 200 in the illustration in FIG. 1. The third step 300 now takes place in the area of the service center 2, in which this service center shares its current position P4 together with its identification and a time stamp T8. This data is transmitted to the vehicle 1 in the fourth step 400. In the fifth step 500, the vehicle 1 now calculates the physical position PP4 of the service center 2, for example based on the time stamp T8 and the signal transit times between the service center 2 and satellites 3.1, 3.2, 3.3 and 3.4 shown in the FIGS. 2ff and, optionally, with the involvement of a satellite control center. At the end of this fifth step 500 it can then be checked whether the thus calculated position PP4 corresponds to the shared position P4. If it does, the communication is validated accordingly and in return the unique position with the unique ID and a unique time stamp 9 is compiled in a sixth step 600 and sent to the service center 2 in the seventh step 700 together with a confirmation of the validation by the vehicle 1. If P4 and PP4 do not match, communication is aborted by the vehicle 1 in step 610.

In an eighth step 800, the check performed in the fifth step 500 in the vehicle 1 is then also carried out by the service center 2. In this eighth step, denoted 800 here, the service center 2 therefore determines the same data in the same way and then arrives at a calculated position PP3 without the vehicle V1 being able to actively influence the determination of this value. This position is reliable, just as the position PP4 of the service center 2 was previously, regardless of whether the vehicle 1 has or has not been hacked. If the determined position PP3 and the shared position P3 are the same again in the step 900, then the validation is also carried out by the service center 2, which validation is shared with the vehicle in a tenth step 1000. Otherwise, the method is aborted in step 910.

Following a positive validation of both subscribers 1, 2, a secure communication can then take place, for example in the step shown here with 1100 as bidirectional communication. The security of this communication is accordingly high, since, as already described above in the introduction to the description, it is virtually impossible or only possible with extreme effort for hackers to interfere with this communication due to the verification of the physical property in the form of the position of the subscribers 1, 2. In the context of this communication in the tenth step 1000, the software update from the service center 2 can then be installed on the vehicle 1, for example. In this case it is possible for this communication to be secured with a one-time key which is only valid for the current communication, so that after the end of the communication this key is also virtually worthless if it falls into the wrong hands.

The illustration in FIG. 2 now shows a first scenario for identifying the positions by means of the signal transit time (transfer time—TT) of satellites 3.1, 3.2, 3.3, 3.4. By way of example, four satellites 3.1, 3.2, 3.3, 3.4 are shown above the earth's surface 4, of which the three satellites 3.1, 3.2, 3.3 are used to identify the position, with the fourth satellite 3.4 being used in a manner known per se to synchronize the time.

Starting from the satellite 3.1, a circle labelled with 5.1 can be described on the earth's surface on the basis of the signal transit time Δt1 of the first satellite 3.1, as shown by a dotted line. The transit time from each point on this circle 5.1 to or from the respective satellite 3.1 is the same. In the case of a certain transit time Δt1 of a signal, it is therefore only possible to determine that the desired point is one of the points of the circle 5.1. At the same time, the method now analyzes the transit time Δt2 of signals from the second satellite 3.2. This also results in a circle with points with the same signal transit time Δt2, which is shown here by a dash-dotted line and labelled 5.2. This has the result that only two intersection points remain between the two circles 5.1 and 5.2 in the exemplary embodiment shown here, so that the possible position of vehicle 1, purely by way of example here, is already limited accordingly. Via a third satellite 3.3 and signal transit times Δt3 of signals from this satellite, a third circle 5.3 can be determined accordingly, which now leads to a unique intersection point of these three circles 5.1, 5.2, 5.3 and it is thus possible to determine the position of the vehicle 1 shown here on the earth's surface 4.

The fourth satellite 3.4 shown here can now be used on the one hand to compensate for transit time errors due to refraction at the ionosphere and also to synchronize the clock times, since typically the system in the vehicle 1 and the satellites do not have clocks with sufficiently high accuracy that such a synchronization can be dispensed with, which is why in practice an additional satellite is necessary and routine for this purpose.

If the vehicle 1 is now replaced as the authorized first subscriber 1 by a hacker, denoted here by way of example as a circle labelled 1*, then this is located purely by way of example on the circle 5.1, but not on the other circles 5.2 and 5.3, which ultimately give the exact position of the vehicle 1. Instead, the hacker 1* pretends to be the vehicle 1. The position identification now results from the same first signal transit time Δt1. However, the two other signal transit times Δt2* and Δt3* of the hacker differ from the original transit times Δt2 and Δt3, which apply to the transmitted position of the vehicle 1, so that a deviating position can be determined here. The communication is accordingly aborted.

This first method therefore uses the transit time of the signals, the so-called transfer time (TT). This first described method is based substantially on the method described in DE 10 2020 003 329 A1. If fewer satellites are visible, the method from DE 10 2021 003 610 A1 mentioned in the introduction could of course also be used here as an alternative.

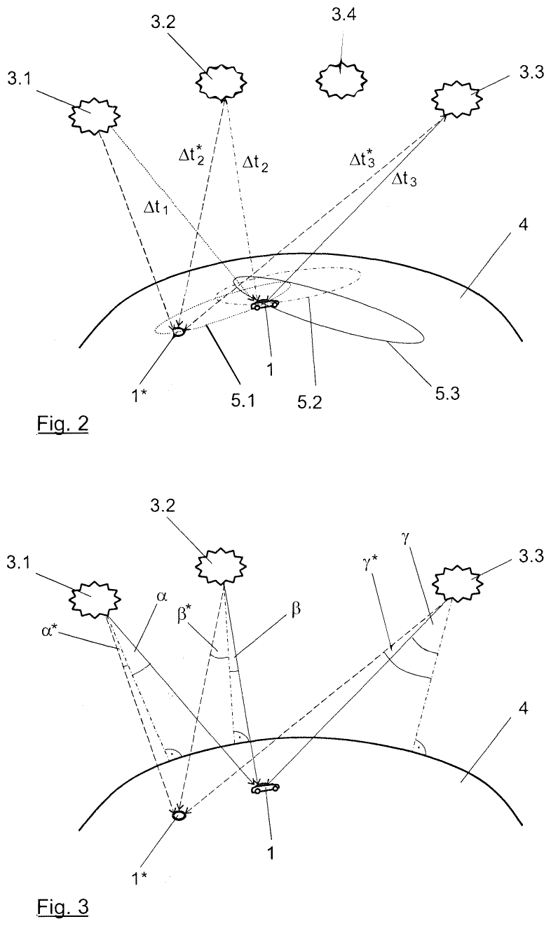

An alternative way of identifying the position via the signal transit time TT is to use an angle of arrival (AoA) of the signals. To detect such an angle of arrival with sufficient accuracy, an array of a plurality of antennas is required to detect not just the signal but also the angle of arrival thereof. In a scenario comparable to FIG. 2 and shown in FIG. 3, this angle of arrival AoA would now lead to angles of arrival of the signals in the case of the real vehicle 1, e.g., relative to an imaginary vertical connection of the respective satellite 3.1, 3.2, 3.3 to the earth's surface 4, which are labelled here with α, β and γ. Analogously to the design in FIG. 2, a hacker 1* located at another position would in turn generate other angles of arrival of the signals. These are labelled here with α*, β* and γ*. The deviation of the angles indicates that the specified position does not match the actual position, i.e. the authentication has failed.

If the subscriber 1, 2, whose position is to be checked for the authentication, is not, as shown in FIGS. 2 and 3, the vehicle 1 but the service center 2, which has a unique position on the earth's surface 4, then this position can also be saved within the system, for example in a vehicle 1, in order to be able to dispense with the transmission by the service center 2. In particular, a vehicle manufacturer can already implement the exact position of their service center 2 in their vehicles 1, in particular depending on the region, in the control systems.

A further alternative could be that the satellites 3.1, 3.2, and 3.3 accordingly monitor the arrival signals; the satellite 3.4 is no longer necessary in the scenario according to FIG. 3. The comparison could then be made directly via the satellites 3.1, 3.2, 3.3, which then have a part of the communication device needed to establish the secure communication, based on their own stored data or data previously requested from another subscriber, for example a service center as subscriber 2. Signals from an obvious hacker 1* whose data arrives at the satellites 3.1, 3.2, 3.3 with false angles of arrival AoA could then be immediately discarded and not forwarded to the other subscriber 2.

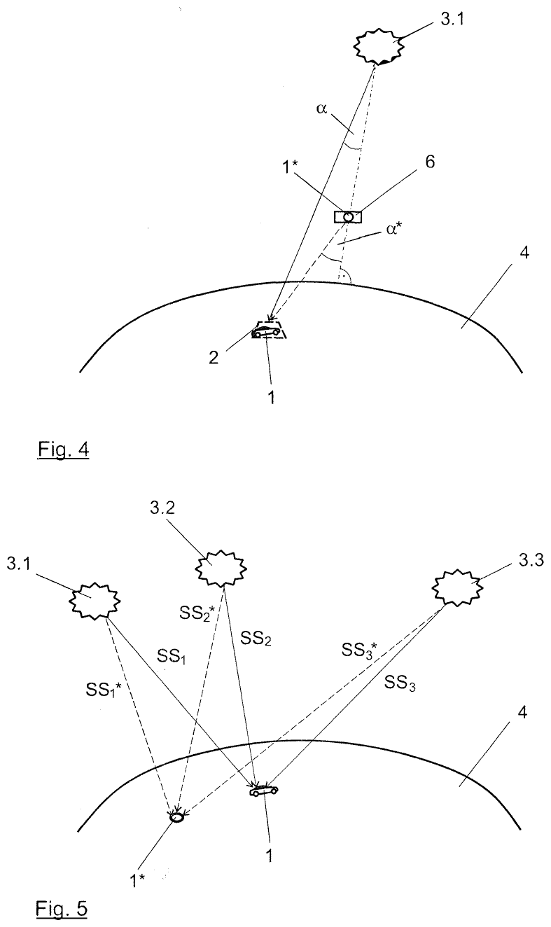

FIG. 4 now shows a further scenario in which, purely by way of example, only one of the satellites 3.1 is shown. Here again, a vehicle 1 acts as subscriber 1, however the service center 2 could also take its place as subscriber 2, which is indicated here by a dashed line. In this scenario the hacker 1* pretends to be the network, i.e., attempts to manipulate the communication via a fake satellite. In this case, for example, a high-flying drone 6 would pretend to be the satellite 3.1 to the subscribers 1, 2 or one of the subscribers 1, 2. In this case, an incorrect angle α* relative to the vertical to the earth's surface could also be detected and analyzed by analyzing the angle of arrival at the subscribers 1, 2 or the subscriber 1, 2 for a signal sent by the drone 6 relative to the expected angle of arrival of the signal α at the real satellite 3.1 in order to discover the manipulation.

The illustration in the FIG. 5 now takes up a further scenario in which instead of the signal transit time TT or the angle of arrival AoA of the signals, the signal strength (SS) of the signals is accordingly analyzed. This signal strength SS depends on the one hand on the distance and on the weather conditions present on the route, such as humidity, clouds, rain or the like. This results in a triple of signal strengths SS1, SS2, SS3 for the subscriber 1 when correspondingly communicating with satellites 3.1, 3.2 and 3.3, which are relatively unique for its position, where a certain degree of tolerance is always to be expected for the signal strength SS due to the atmospheric conditions. However, if the position of the hacker 1* is significantly different, the signal strengths SS1*, SS2*, SS3* for this hacker are also significantly different in the comparison. This also allows any incorrect positioning to be recognized so that communication can be aborted in good time and manipulation prevented.

It is particularly expedient to combine the various methods TT, AoA, and/or SS with one another. For example, the signal transit time TT can be used to ascertain the position for the purpose of authenticating the subscribers 1, 2. This result can then be validated using the angle of arrival AoA and/or the signal strength SS in order to ensure that the signal transit time TT has not been manipulated in any way.

There is a certain degree of limitation in the case of the signal strength SS, since this can be manipulated comparatively easily if the losses occurring on the way are known or can be estimated. A hacker can then adapt the transmission power accordingly to generate the desired signal strength. At the same time, as this must be provided with a relatively large tolerance band due to the possibility of changing atmospheric conditions and/or weather conditions, the risk of manipulation cannot be entirely ruled out.

To reduce this risk even further, the sent signal can additionally be provided with encryption that varies dynamically over time. Here, for example, the signal strength, the frequency, the amplitude or even the polarization of the signal can be varied over time. If this follows a predefined pattern, which is stored accordingly in the communication devices of the actual subscribers 1, 2, this variation, which is created by the sending subscribers 1, 2, can be filtered out by the receiving subscribers 2, 1 in order to be able to analyze the actual signal strength. This further increases protection against a potential manipulation.

Of course, it is also possible to interchange the various methods in this technique, for example to perform the actual authentication via the angle of arrival AoA and the validation via the signal transit time TT and/or the signal strength or the actual authentication via the signal strength, etc. As an alternative, two of the methods can also be used for the authentication and, in the case of identical authentication of these two methods, the third method can be used for the validation or all three methods can be used for the authentication or an appropriate mix of the various methods can be used in any way. In particular, this mix can be changed again and again depending on various parameters in order to increase security even further.

Although the invention has been illustrated and described in detail by way of preferred embodiments, the invention is not limited by the examples disclosed, and other variations can be derived from these by the person skilled in the art without leaving the scope of the invention. It is therefore clear that there is a plurality of possible variations. It is also clear that embodiments stated by way of example are only really examples that are not to be seen as limiting the scope, application possibilities or configuration of the invention in any way. In fact, the preceding description and the description of the figures enable the person skilled in the art to implement the exemplary embodiments in concrete manner, wherein, with the knowledge of the disclosed inventive concept, the person skilled in the art is able to undertake various changes, for example, with regard to the functioning or arrangement of individual elements stated in an exemplary embodiment without leaving the scope of the invention, which is defined by the claims and their legal equivalents, such as further explanations in the description.

1-12. (canceled)

13. An apparatus configured to establish a secure communication between a first and second communication device, wherein the apparatus is configured to:
determine a current geodetic position of the one of the first and second communication devices;
compare the current geodetic position of the one of the first and second communication devices with a received position or stored position of the one of the first and second communication devices or check plausibility of the received position or stored position of the one of the first and second communication devices based on the current geodetic position of the one of the first and second communication devices,
wherein the current geodetic position of the one of the first and second communication devices is determined based on an angle of arrival or a signal strength of communication signals received by the one of the first and second communication devices from one or more satellites, and
wherein a transmit time of signals received by the one of the first and second communication devices from the one or more satellites is also used to determine the current geodetic position of the one of the first and second communication devices.

14. The apparatus of claim 13, wherein the apparatus has an antenna array.

15. The apparatus of claim 13, wherein the apparatus is configured to test a signal strength of signals sent by the one of the first and second communication devices according to a given pattern and to filter signals received from the one of the first and second by communication devices according to the given pattern.

16. The apparatus of claim 13, wherein the apparatus is part of the first and second communication devices.

17. The method of claim 13, wherein the apparatus is part of the one or more satellites.

18. A method of attempting to establish a secure communication between a first and second communication device, the method comprising:
determining a current geodetic position of the one of the first and second communication devices;
comparing the current geodetic position of the one of the first and second communication devices with a received position or stored position of the one of the first and second communication devices or check plausibility of the received position or stored position of the one of the first and second communication devices based on the current geodetic position of the one of the first and second communication devices; and
establishing or terminating the secure communication between the first and second communication device based on the comparison or the plausibility check,
wherein the current geodetic position of the one of the first and second communication devices is determined based on an angle of arrival or a signal strength of communication signals received by the one of the first and second communication devices from one or more satellites, and
wherein a transmit time of signals received by the one of the first and second communication devices from the one or more satellites is also used to determine the current geodetic position of the one of the first and second communication devices.

19. The method of claim 18, wherein the current geodetic position is determined based on the angle of arrival of the communication signals received by the one of the first and second communication devices from one or more satellites and the transmit time of the signals received by the one of the first and second communication devices from the one or more satellites.

20. The method of claim 18, wherein the current geodetic position is determined based the signal strength of communication signals received by the one of the first and second communication devices from one or more satellites and the transmit time of the signals received by the one of the first and second communication devices from the one or more satellites.
